(19) United States
(12) Patent Application Publication
(10) Pub. No.: US 2017/0341634 A1
(43) Pub. Date: Nov. 30, 2017

(54) MOTOR VEHICLE BRAKE SYSTEM CONTROLLER AND METHOD

(71) Applicant: Continental Teves AG & Co. oHG, Frankfurt (DE)

(72) Inventor: Andreas Heise, Erzhausen (DE)

(73) Assignee: Continental Teves AG & Co. oHG, Frankfurt (DE)

(21) Appl. No.: 15/681,924

(22) Filed: Aug. 21, 2017

Related U.S. Application Data
(63) Continuation of application No. PCT/EP2016/054209, filed on Feb. 29, 2016.

(30) Foreign Application Priority Data
Mar. 2, 2015 (DE) 10 2015 203 700.2
Dec. 9, 2015 (DE) 10 2015 224 708.2

(51) Int. Cl. B60T 13/66; B60T 17/22

(52) U.S. Cl. CPC B60T 13/662; B60T 17/221; B60T 2201/10; B60T 2270/403; B60T 2270/402

(57) ABSTRACT

A controller for a motor vehicle brake system includes a first functional assembly for controlling a service brake and a second functional assembly for controlling a parking brake. The first and the second functional assemblies can be supplied by separate voltage supplies. The controller is configured in such a way that, in the event of a fault in or affecting the first or the second functional assembly, the respective other functional assembly remains ready for use for at least a defined period of time, and the motor vehicle can be braked by means of the ready-for-use functional assembly within the defined period of time in order to engage a transmission lock of the vehicle and/or in order to hold the vehicle at a standstill using the parking brake.

### CROSS REFERENCE TO RELATED APPLICATIONS

This application claims the benefit of International application No. PCT/EP2016/054209, filed Feb. 29, 2016, which claims priority to German application No. 10 2015 203 700.2, filed Mar. 2, 2015, and German application No. 10 2015 224 708.2, filed Dec. 9, 2015, each of which is hereby incorporated by reference.

### TECHNICAL FIELD

The technical field relates generally to a brake system and more particularly to a controller for a motor vehicle brake system.

### BACKGROUND

Driver assistance systems have become increasingly complex in recent years. In addition to the systems that make driving easier for the driver, systems that can move the vehicle without the driver being situated in the vehicle are being used to an increasing extent. Such functions are, e.g., highly automated parking. There are different versions thereof. The vehicle moves, e.g., into a parking space or out of a parking space, wherein the driver can initiate, interrupt, or terminate the parking or unparking process by means of remote control, e.g., a cellular phone or the vehicle key. Such functionalities can also be scaled to parking garages in which the vehicles can move entirely or partially without a driver, wherein flat areas or upward-sloping or downward-sloping sections are present.

Vehicles that have such functionalities must be capable of safely coming to a standstill in the event of an interference of participating system, e.g. the system for the remote control of the vehicle. In the event of the failure of the brake system in particular, the vehicle must nevertheless be able to be reliably brought to a standstill and held there. The requirements on systems for highly automated driving are therefore higher than for presently-used systems.

In the case of a central brake controller, a microprocessor-controlled safety architecture is usually provided, which switches off, with the aid of a redundant calculation and often redundant switch-off paths as well, when a fault occurs, in order to reach a safe state. In this case, faults can be, for example, in the voltage supply in microprocessor circuits or, e.g. as a result of a fire on a printed circuit board of the brake controller.

The failsafe architecture for regulation faults by the brake system, which is chosen for safety reasons, results in a complete or partial shutdown of the brake controller, whereby a reliable and automatic stop without driver intervention is no longer possible. In addition, when the voltage supply (on-board electrical system) fails, an automated actuation of the service brake is no longer possible. On an incline, the vehicle would continue to roll in an uncontrolled manner, for example, or can even accelerate.

As such, it is desirable to present a controller for a motor vehicle system, by means of which the requirements of highly automated parking can be met. In particular, it is desirable that the vehicle can be braked to a standstill when an internal fault occurs or when an interference occurs during a highly automated parking process. In addition, other desirable features and characteristics will become apparent from the subsequent summary and detailed description, and the appended claims, taken in conjunction with the accompanying drawings and this background.

### BRIEF SUMMARY

A controller for a motor vehicle brake system includes a first functional assembly for controlling a service brake and a second functional assembly for controlling a parking brake, wherein the first and the second functional assemblies can be supplied by separate voltage supplies, and the controller is configured in such a way that, in the event of a fault in or affecting the first or the second functional assembly, the respective other functional assembly remains ready for use for at least a defined period of time, and the motor vehicle can be braked by means of the ready-for-use functional assembly within the defined period of time in order to engage a transmission lock of the vehicle and/or in order to hold the vehicle at a standstill using the parking brake. In other words, the controller is advantageously designed in such a way that effects on the respective other brake function, i.e., the service brake or the electrical parking brake (still referred to in the following only as the parking brake), due to, for example, damage, a short circuit, water ingress, etc., can be avoided at least for the defined time period, and this respective other brake function likely fails only after this time period. By ensuring the functionality of at least one of the brake functions (service brake or parking brake) for, for example, at least approximately 1 second after the occurrence of an interference or in the event of consequences for at least one of the brake functions/functional assemblies, the vehicle or its wheels can be advantageously braked within this time period in such a way that the vehicle either cannot permanently continue to roll (parking brake) or, in particular after a failure of the service brake, the locking pawl of an automatic transmission (transmission lock) is automatically triggered at low speed, and then the failure of the service brake system, which usually cannot permanently lock, is tolerable, since a continued rolling of the vehicle is also prevented. The vehicle is advantageously braked to a speed (e.g., <2 km/h) or to a standstill, and so the locking pawl can be securely engaged in the automatic transmission or, in the event that a minimum speed is fallen below, automatically currentlessly drops into the lock, and/or the vehicle is braked to a standstill by means of the parking brake and, at a standstill, can continue to be held at a standstill with the aid of the parking brake, wherein, in addition, the transmission lock can hold the vehicle at a standstill. For example, the controller housing does not fill up more rapidly than in one second, under normal conditions, in the event of water ingress resulting from a damaged housing during the automated parking operation, and so braking to a standstill can still be carried out. In addition, as a result of the combination of the parking brake with the service brake in one controller, advantages result with respect to additional fallback modes (additional safety) and a comfort-oriented behavior for the vehicle passengers. A functional assembly is, for example, a microprocessor, a microcontroller, or a control unit. An automated parking process should be understood to mean the computer-assisted, automated movement of a vehicle into a standstill position—which is desired, in particular—or out of a standstill position. In addition, a housing and/or further components of the controller can be designed in such a way that the separation for ensuring the defined time for maintaining the proper performance of at least one of the brake functions is improved.

A controller is advantageously provided, which requires only a slight amount of additional outlay as compared to the prior art, but which can be used for vehicles that support HAP (highly automated parking), and in vehicles without HAP. The control of the parking brake and the highly automated parking can therefore take place with one central controller.

According to an embodiment, the first functional assembly and the second functional assembly are separated from each other in such a way that the defined time period of the remaining state of readiness is ensured. This separation is configured in such a way that, in the event of a fault that affects at least one of the functional assemblies, the respective other functional assembly continues to remain operational for a defined time period, e.g., approximately one second. This can be implemented, in particular, by means of design measures, such as, for example, an appropriate design of a housing of an underlying controller and/or a functional and, optionally, electrical separation of applicable functional assemblies. This separation can also be advantageously implemented on a circuit board comprising the functional assemblies. The controller is configured in such a way that the first functional assembly and the second functional assembly are designed for joint communication, for example in order to allow for a unilateral or mutual checking of the supply and/or functionality.

In one embodiment, at least one detection circuit is provided for detecting an interruption of a supply potential and/or a reference potential of at least one of the power supplies. Advantageously, these are voltage supplies and/or voltage sources that are essentially independent of each other. If one of the voltage supplies fails, this can be advantageously detected and appropriate measures, such as, for example, braking the vehicle to a standstill, can be implemented. According to one embodiment, at least one of the separate voltage supplies is implemented in a buffered manner in such a way that the particular assigned functional assembly remains suppliable at least for the defined time period.

The controller may advantageously be configured including a shared plug, which has a suitable arrangement of the plug pins, for the supply of the service brake and the parking brake.

The disclosure also describes a method to be carried out in a motor vehicle controller which comprises a first functional assembly for controlling a service brake and a second functional assembly for controlling a parking brake, wherein the first and the second functional assemblies can be supplied by separate voltage supplies and, in the event of a fault in or affecting the first or the second functional assembly, the respective other functional assembly remains ready for use for at least a defined period of time, and the motor vehicle can be braked by means of the ready-for-use functional assembly within the defined period of time in order to engage a transmission lock of the vehicle and/or in order to hold the vehicle at a standstill using the parking brake.

According to one advantageous refinement of the method, the second functional assembly is monitored by the first functional assembly when both assemblies are in ongoing operation.

A control of a parking brake operated by the second functional assembly may take place on demand or when permitted by the first functional assembly. According to one embodiment, a control of a parking brake operated by the second functional assembly takes place when the first functional assembly permits an automatic control by the second functional assembly or as a consequence of a fault in or affecting the first functional assembly.

The method may be carried out during an automated parking process. According to one advantageous embodiment of the method, during an automated parking operation, there is an operation of the parking brake by the second electronic assembly that is independent of the first electronic assembly. In this case, the automated parking operation includes, in particular, automated parking and unparking processes. In particular in the case of an interference or a fault affecting the first functional assembly during the HAP operation, the parking brake can be advantageously independently activated by the second functional assembly and the vehicle can be brought to a standstill.

The disclosure also relates to a brake system which includes a controller as described above.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows an exemplary embodiment of a brake system including a functional assembly for operating a service brake and a parking brake with the aid of a voltage supply;

FIG. 2 shows the brake system including a functional assembly for operating the service brake and the parking brake with the aid of two separate voltage supplies;

FIG. 3 shows the brake system including a functional assembly for operating the service brake and a functional assembly for operating the parking brake, which are separated from each other and have an independent voltage supplies which can communicate with each other by means of a communication interface;

FIG. 4 shows the brake system including the functional assembly for operating the service brake and the functional assembly for operating the parking brake, which are separated from each other and have an independent voltage supplies and which can communicate by means of the communication interface, and include a detection circuit for detecting an interruption of the potential or potentials; and

FIG. 5 shows the functional assembly for operating the parking brake with the aid of an associated supply voltage and an included circuitry part for the autonomous operation of the parking brakes.

### DETAILED DESCRIPTION

Identical elements are provided with identical reference characters in order to allow for a brief and simple description of the exemplary embodiments.

FIG. 1 shows a brake system 1 including a controller 1.1 which includes a functional assembly G1 for controlling service brake actuators (not shown) and two parking brake actuators or parking brake actuators EPB-L and EPB-R, and which is supplied by a voltage supply U1, GND1. The service brake actuators are not represented in FIGS. 1 to 5, but they are provided in the actual implementation.

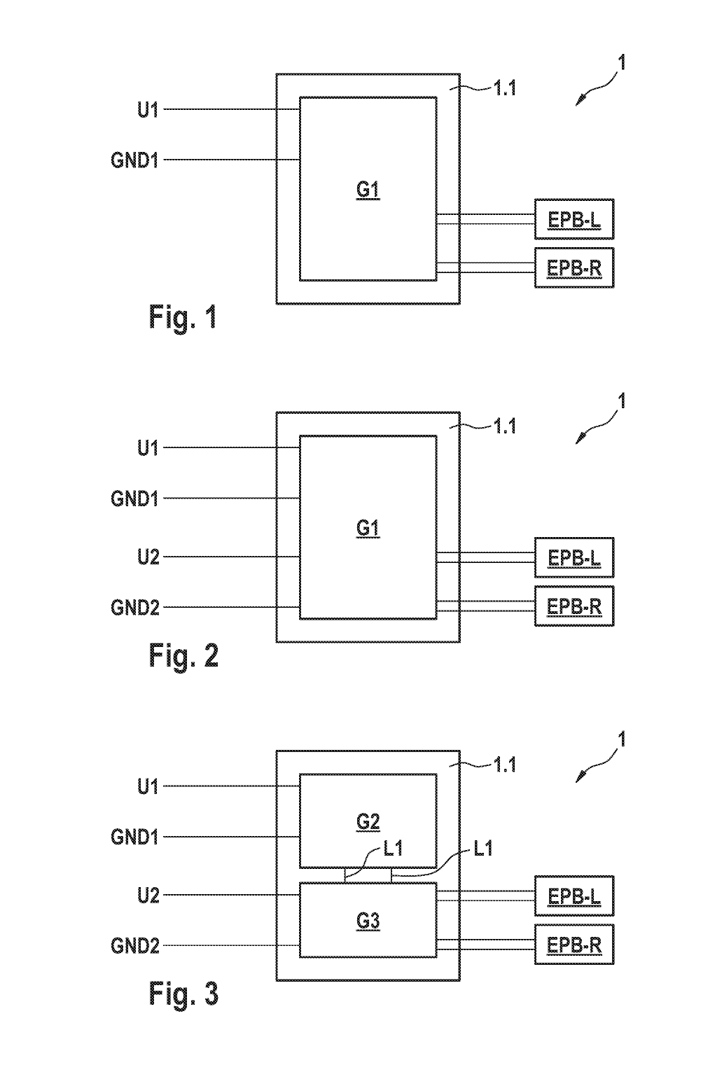

According to one exemplary embodiment, one further voltage supply U2, GND2, which is as independent as possible, is integrated in the vehicle, as shown in FIG. 2, and is also provided, in addition to voltage supply U1, GND1, for supplying controller 1.1 and the functional assembly G1. At least one of the supply voltages can also be implemented in a buffered manner, and so, in the event of failure of this voltage supply for a limited time, a continued operation of the service brake and/or the parking brake is possible by means of the functional assembly G1, e.g., a microprocessor or control unit. The voltage supply U2, GND2 and, optionally, further electrical connections can be transmitted via an additional electrical plug connector or, by way of an appropriate design, via a plug shared with the first voltage supply U1, GND1. The reference potential can be provided via two lines GND1, GND2 or via a shared line when a continued operation of at least one of the brake functions by brake system 1 can be ensured in the event of an interruption of this shared line. A detection of a failure of the reference potential connection or one of the reference potential connections GND1, GND2 and/or the supply potentials U1, U2 is provided.

According to the refinement of the brake system 1, as shown in FIG. 3, the functional assembly G3 for controlling the parking brake actuators EPB-L, EPB-R is designed separated from the functional assembly G2 for controlling the service brake actuators in such a way that an improved availability can be implemented. The separated assemblies are supplied by an independent voltage supply U1, GND1 or U2, GND2, respectively, wherein implementations—e.g., a shared plug—of the type that were described for the exemplary embodiment according to FIG. 2, can be provided. This separation is designed in such a way that, in the event of a fault that affects at least one of the functional assemblies G2, G3, the respective other functional assembly (having an independent voltage supply) continues to remain operational for a defined time period, e.g., approximately one second, wherein an implementation on a shared circuit board can also be provided. The vehicle can be safely braked in this time period, and so the parking brake or the transmission lock can secure the vehicle. The separated functional assemblies do not necessarily need to be assigned to the same safety integrity level (e.g. ASIL). For example, a design of the functional assembly for controlling the parking brake—in particular also in the HAP operating mode—for a classification into a level that is as high as that of the main processor or the functional assembly for actuating the service brake could be dispensed with.

Interface L1 is provided for the communication of the functional assemblies G2 and G3. The functional assembly G3 for controlling the parking brake actuators EPB-L, EPB-R essentially takes over all parking brake actuations—even in an HAP operating mode—and, provided the main processor of the controller, which may be included in the functional assembly G2 for controlling the service brakes, is operating, the functional assembly G3 is monitored by this main processor via communication interface L1. Functional assembly G3 therefore monitors functional assembly G2 with respect to faults or interferences that occur.

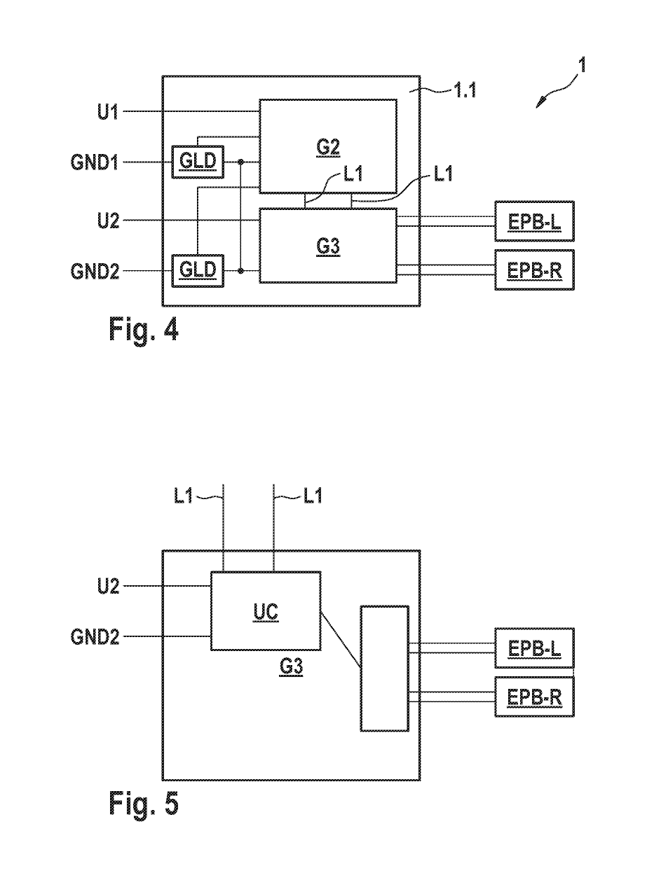

According to this configuration, the functional assembly G3 for controlling the parking brake actuators can be secondary (e.g. slave) to the primary functional assembly G2, i.e., hierarchically subordinate thereto in terms of function; according to this example, the primary functional assembly G2 is designed for controlling the service brakes. The activation of the parking brake control may be logically (electronically) locked in such a way that the actuation of the parking brake actuators takes place exclusively when the functional assembly G2 requires or permits this or the HAP operating mode is activated and the functional assembly G3 has been authorized for controlling the parking brake actuators for autonomous operation and/or automatically activates the parking brakes after a detection of a fault of the main processor. This is illustrated according to the functional assembly G3 shown in FIG. 5—for example, for an embodiment of the brake system 1 according to FIG. 3 or FIG. 4—by a circuitry part UC included in this assembly. In this case, the circuitry part UC provides for the (autonomous) operation of the parking brake actuators EPB-L, EPB-R by assembly G3 independently of functional assembly G2. Instead of an additional microprocessor as the secondary assembly, a circuit, e.g. a control unit, can be provided, which is designed for automatically activating the parking brake actuators in the event of a fault of the primary assembly.

As compared to the embodiment according to FIG. 3, the exemplary embodiment of brake system 1 or of the controller 1.1 according to FIG. 4 additionally comprises the detection circuits GLD for the detection of an interruption of the GND potential or potentials. Alternatively, or in addition, at least one detection circuit can be provided for the detection of an interruption of at least one of the supply potentials (not shown).

According to another embodiment (not shown), a switch from the primary assembly to the secondary assembly takes place by means of a multiplexer when the HAP operating mode is triggered by the primary assembly or the main processor, so that the secondary assembly can carry out a braking by means of the parking brake actuators in the event of a fault of the primary assembly or the main processor.

The present disclosure has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A controller for a motor vehicle brake system, the controller comprising:
a first functional assembly for controlling a service brake; and
a second functional assembly for controlling a parking brake;
wherein the first and the second functional assemblies may be supplied by separate voltage supplies;
wherein the controller is configured that, in the event of a fault in or affecting the first or the second functional assembly, the respective other functional assembly remains ready for use for at least a defined period of time, and the motor vehicle can be braked by the respective other functional assembly within the defined period of time in order to engage a transmission lock of the vehicle and/or in order to hold the vehicle at a standstill using the parking brake.

2. The controller as claimed in claim 1, wherein the first functional assembly and the second functional assembly are separated from each other in such a way that the defined time period of the remaining state of readiness is ensured.

3. The controller as claimed in claim 1, further comprising at least one detection circuit configured to detect an interruption of a supply potential and/or a reference potential of at least one of the power supplies.

4. The controller as claimed in claim 1, wherein at least one of the separate voltage supplies is implemented in a buffered manner in such a way that the particular assigned functional assembly remains suppliable at least for the defined time period.

5. A method to be carried out in a motor vehicle controller which comprises a first functional assembly for controlling a service brake and a second functional assembly for controlling a parking brake, wherein the first and the second functional assemblies can be supplied by separate voltage supplies, wherein that, in the event of a fault in or affecting the first or the second functional assembly, the respective other functional assembly remains ready for use for at least a defined period of time, and the motor vehicle can be braked by the respective other functional assembly within the defined period of time in order to engage a transmission lock of the vehicle and/or in order to hold the vehicle at a standstill using the parking brake.

6. The method as claimed in claim 5, wherein the second functional assembly is monitored by the first functional assembly when both assemblies are in ongoing operation.

7. The method as claimed in claim 5, wherein a control of a parking brake operated by the second functional assembly takes place on demand or when permitted by the first functional assembly.

8. The method as claimed in claim 5, wherein a control of a parking brake operated by the second functional assembly takes place when the first functional assembly permits an automatic control by the second functional assembly or as a consequence of a fault in or affecting the first functional assembly.

9. The method as claimed in claim 5, wherein during an automated parking operation, there is an operation of the parking brake by the second electronic assembly that is independent of the first electronic assembly.

10. A brake system including a controller, the controller comprising:
a first functional assembly for controlling a service brake; and
a second functional assembly for controlling a parking brake;
wherein the first and the second functional assemblies may be supplied by separate voltage supplies;
wherein the controller is configured that, in the event of a fault in or affecting the first or the second functional assembly, the respective other functional assembly remains ready for use for at least a defined period of time, and the motor vehicle can be braked by the respective other functional assembly within the defined period of time in order to engage a transmission lock of the vehicle and/or in order to hold the vehicle at a standstill using the parking brake.
